(19) United States
(12) Patent Application Publication
(10) Pub. No.: US 2008/0053922 A1
(43) Pub. Date: Mar. 6, 2008

(54) NANOSTRUCTURED MATERIALS COMPRISING SUPPORT FIBERS COATED WITH METAL CONTAINING COMPOUNDS AND METHODS OF USING THE SAME

(76) Inventors: Charles P. Honsinger JR., Windsor, VT (US); Mikhail Starostin, West Lebanon, NH (US); Christopher H. Cooper, Windsor, VT (US); Andrei Burnin, West Lebanon, NH (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/848,765

(22) Filed: Aug. 31, 2007

Related U.S. Application Data
(60) Provisional application No. 60/841,558, filed on Sep. 1, 2006.

(51) Int. Cl. B01D 39/00; B01D 37/02; B05D 1/12; B32B 19/00

(52) U.S. Cl. 210/777; 210/508; 427/180; 427/596; 428/364

(57) ABSTRACT

Disclosed herein are fibers comprising an active material that assists in removing contaminants from fluid. The active material, which forms a coating on the fiber, typically comprises a non-fibrous: nanostructured, metal-containing compound, such as a metal-oxygen compound. A filter media made of such fibers, as well as methods of making the fiber and the filter media are also disclosed. Methods of purifying fluids, such as air, water, and fuels, are further disclosed.

This application claims priority to U.S. Provisional Application No. 60/841,558, filed Sep. 1, 2006, all of which is incorporated herein by reference in its entirety.

Disclosed herein are fibers coated with at least metal-containing compound, such as a metal-oxygen compound and materials made of such coated fibers. Also disclosed are methods of coating such fibers. Filter media made of such fibers, as well as methods of purifying fluids, such as air, water, and fuel using the disclosed filter media are also disclosed.

Nanostructured materials have shown extraordinary promise due to their high surface areas, and other features that make them useful in a number of fields. For example, in the purification sector they are particularly beneficial for their high surface area, which enables contaminants to be removed from fluid by size exclusion, attractive forces, or both.

The nanostructured materials can be further tailored and improved to exhibit an even broader range of properties by coating them with various materials, including metals, polymers and ceramics. To date, most coatings for nanostructures have been created using deposition methods such as physical or chemical vapor deposition techniques. Such techniques common to the art include CVD, MOCVD, and various sputtering techniques. In addition to being very costly and complex, these methods have limitations, including the inability to produce large quantities of material in a single batch. A novel method that would allow large quantities of nanostructures to be coated at a lower overall cost than current methods would allow for larger use of these materials.

Coupled with the foregoing is an interest from both private and industrial sectors for the improvement of filtration, purification, and separation of fluids. There are many procedures and processes to treat fluids for consumption, use, disposal, and other needs. Among the most prevalent procedures are chemical treatments to sterilize water, distillation to purify liquids, centrifugation, and filtration to remove particulates (in both liquid and air), decanting to separate two phases of fluids, reverse osmosis and electrodialysis to de-ionize liquids, pasteurization to sterilize foodstuffs, and catalytic processes to convert undesirable reactants into useful products. Because each of these methods is designed for specific applications, a combination of methods is typically needed to achieve a final product.

In addition, the increasing need for potable drinking water has necessitated more-effective filter media. For example, the U.S. Environmental Protection Agency's (EPA's) recent reduction in the maximum contamination level (MCL) for arsenic in drinking water from 50 ppb (part per billion) to 10 ppb has led to a great number of municipal water plants and private wells not meeting current EPA regulations. Arsenic is even more of a problem in other countries, especially in South-East Asia and South America. For these reasons, there is a need for improved filter media to clean drinking water from contaminants, such as arsenic.

While attempts have been made to use granulated material, it has not been effective for a variety of reasons, including the low flow rate associated with the amount of granulated material required to be used an effective filter media. Therefore, factors to be balanced when treating fluids include the rate of fluid flow, the flow resistance and level of contaminant removal. It would be desirable to have a material that could balance the first two factors, while achieving a higher level of contaminant removal than previously possible.

Many of the current processes can be improved by using articles or filters comprising nanomaterial, such as carbon nanotubes, or nanocarbon fibers coated materials that assist the removal of contaminants. The Inventors have shown in their co-pending applications, including in Ser. No. 10/794,056, filed Mar. 8, 2004, and Ser. No. 11/111,736, filed Apr. 22, 2005, both of which are herein incorporated by reference, that a mesh including carbon nanotubes (a “nanomesh”), properly prepared, can be used to remove a myriad of contaminants from fluid, including viruses, bacteria, organic and inorganic contaminants, salt ions, nano- or micron size particulates, chemicals (both natural and synthetic). These nanomesh materials have also been shown to achieve at least one benefit for use in a filter, such as maintaining or improving the rate of fluid flow through the article, decreasing the flow resistance across the article or lowering the weight of the resulting article.

The Inventors have surprisingly shown that excellent purification properties can be achieved even without the use of carbon nanotubes, when a support fiber is coated with a nanostructured metal oxide material. Due to the small size of the nanostructured metal oxide on the fiber and the large surface area, many of the disclosed materials have shown great promise in drastically reducing the necessary material needed for a filter media. In view of the foregoing, there is a need for improved filtration media for cleaning a variety of fluids, including air and water.

### SUMMARY OF INVENTION

There is disclosed a fiber coated with an active material that assists in removing contaminants or extraction of valuable ions and compounds from fluid, such as air or liquid, including water and fuel. The active material coated on the fiber comprises a non-fibrous, nanostructured, metal-containing compound, such as a metal-oxygen compound.

There is also disclosed a method of coating fibers with a nanostructured material, which comprises depositing onto the fibers, from a liquid and/or gas phase, a non-fibrous, nanostructured, metal-containing compound, such as a metal-oxygen compound in an amount sufficient to decrease the concentration of contaminants in a fluid.

Further, there is disclosed a method for producing a filter media, which comprises forming a liquid suspension of fibers coated with the previously described active material, and depositing the suspension onto a porous substrate. In this method, the deposition is driven by differential pressure.

A method of removing contaminants from fluid using the foregoing filter media, as well as the filter media itself, is also disclosed. The filter media generally comprises a porous substrate that can comprise carbon material, woven material, non-woven material, or combinations thereof. In one embodiment, the porous substrate has a tubular, pleated, or flat shape.

### BRIEF DESCRIPTION OF DRAWING

FIG. 1 is a representation showing a loaded carrier fluid containing fibers coated with a nanostructured metal oxide compound according to the present disclosure.

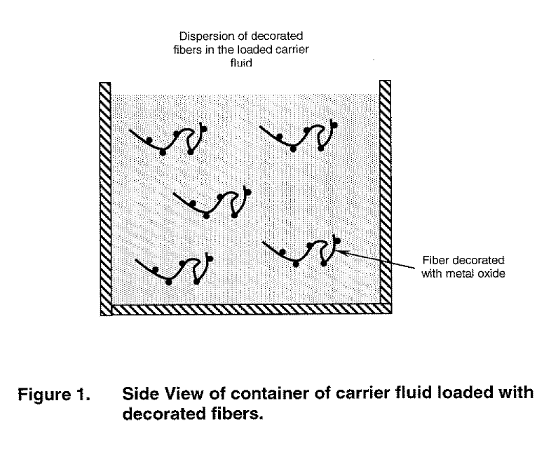

FIG. 2 is a representation of fibers with nano-structured coatings in several none limiting morphologies according to the present disclosure.

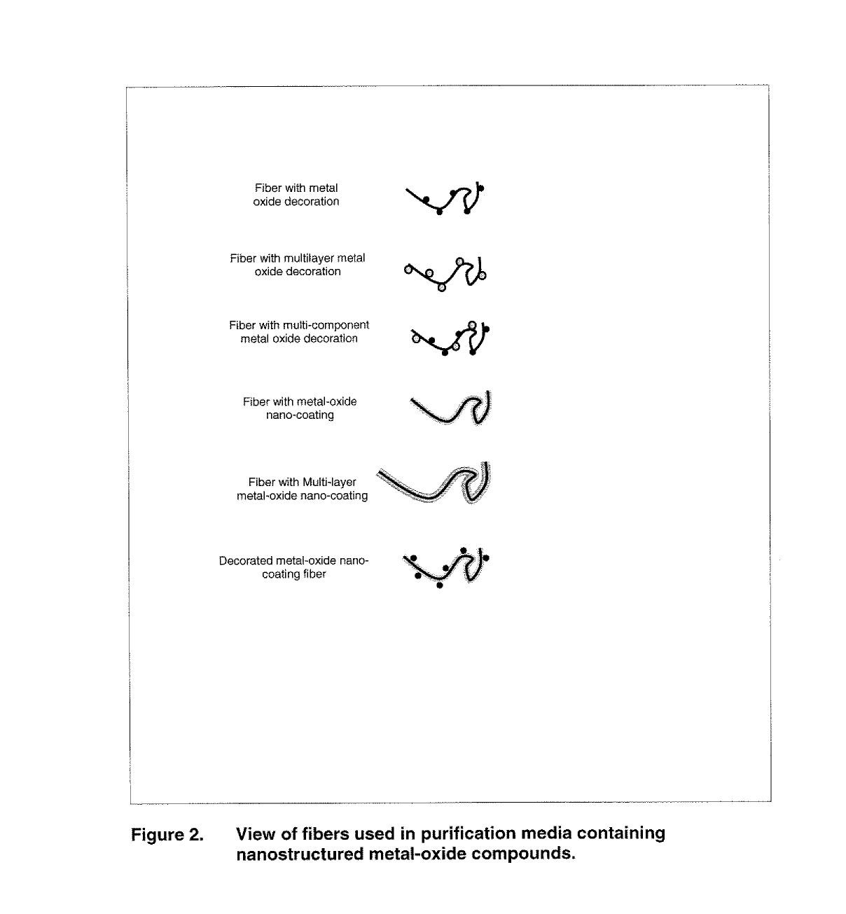

FIG. 3 is a representation of a continuous method for making metal oxide coated fibers according to the present disclosure.

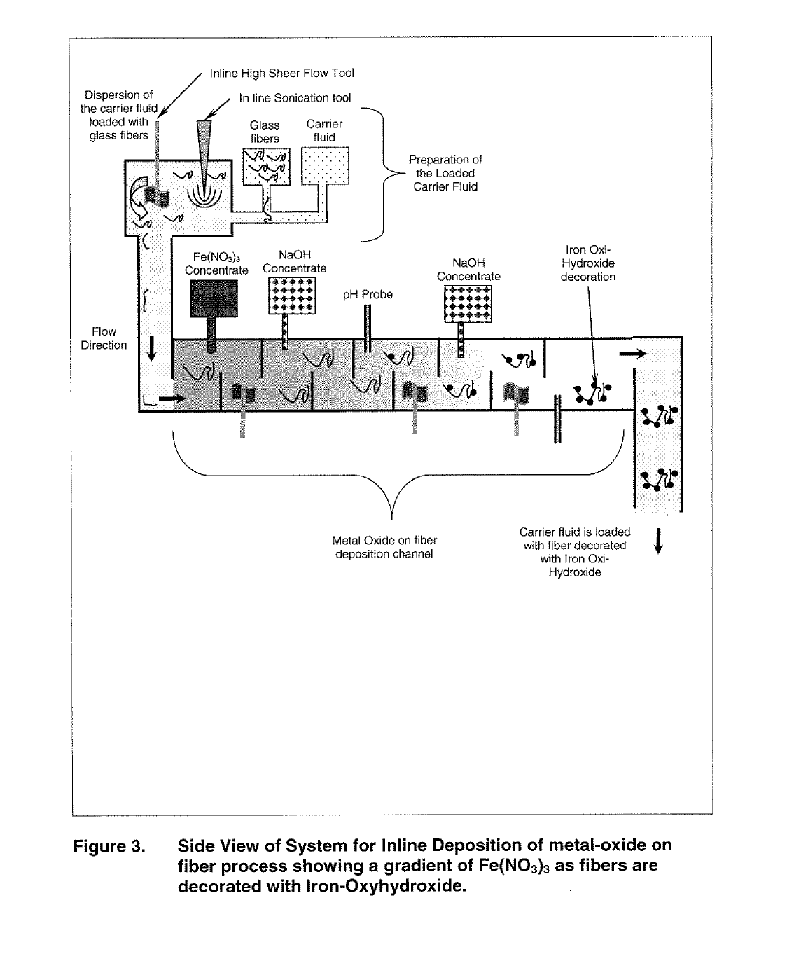

### DETAILED DESCRIPTION OF THE INVENTION

A. Definitions

The following terms or phrases used in the present disclosure have the meanings outlined below:

The term “fiber” or any version thereof is defined as a high aspect ratio. “High Aspect Ratio” is defined as a ratio of at least 10, with fiber diameters and lengths ranging from 1 nm-10 mm. Fibers used in the present disclosure may include materials comprised of one or many different compositions.

The term “nanotube” refers to a tubular-shaped, molecular structure generally having an average diameter in the inclusive range of 1-60 nm and an average length in the inclusive range of 0.1 μm to 250 mm.

The term “carbon nanotube” or any version thereof refers to a tubular-shaped, molecular structure composed primarily of carbon atoms arranged in a hexagonal lattice (a graphene sheet) which closes upon itself to form the walls of a seamless cylindrical tube. These tubular sheets can either occur alone (single-walled) or as many nested layers (multi-walled) to form the cylindrical structure.

The term “coat,” “coating,” or any version thereof is intended to mean a covering layer formed of discrete particles, a contiguous layer of material, or both. In other words, while it is possible, it is not necessary that the “coated” substrate contain a continuous covering layer for it to be considered a “coated” surface, but merely that it contains material covering a portion of the surface. It is noted that if the fibers described herein are hollow, the coating may be found on the inside or outside of the fiber, or both.

The terms “fused,” “fusion,” or any version of the word “fuse” is defined as the bonding of nanotubes, fibers, or combinations thereof, at their point or points of contact. For example, such bonding can be Carbon-Carbon chemical bonding including sp³ hybridization, or chemical bonding of carbon to other atoms, or bonding by forces of physical nature such as electrostatic or Van Der Waals forces.

The terms “interlink,” “interlinked,” or any version of the word “link” is defined as the connecting of nanotubes and/or other fibers into a larger structure through mechanical, electrical or chemical forces. For example, such connecting can be due to the creation of a large, intertwined, knot-like structure that resists separation.

The terms “weaved,” “woven” or any version of the word “weave” is defined as the interlacing of nanotubes and/or other fibers into a larger-scale material.

The terms “nanostructured” and “nano-scaled” refers to a structure or a material which possesses components having at least one dimension that is 100 nm or smaller. A definition for nanostructure is provided in The Physics and Chemistry of Materials, Joel I. Gersten and Frederick W. Smith, Wiley publishers, p382-383, which is herein incorporated by reference for this definition.

The phrase “nanostructured material” refers to a material whose components have an arrangement that has at least one characteristic length scale that is 100 nanometers or less. The phrase “characteristic length scale” refers to a measure of the size of a pattern within the arrangement, such as but not limited to the characteristic diameter of the pores created within the structure, the interstitial distance between fibers or the distance between subsequent fiber crossings. This measurement may also be done through the methods of applied mathematics such as principle component or spectral analysis that give multi-scale information characterizing the length scales within the material.

The term “nanomesh” refers to a nanostructured material defined above, and that further is porous. For example, in one embodiment, a nanomesh material is generally used as a filter media, and thus must be porous or permeable to the fluid it is intended to purify.

The term “functional group” is defined as any atom or chemical group that provides a specific behavior. The term “functionalized” is defined as adding a functional group(s) to the surface of the nanotubes and/or the additional fiber that may alter the surface properties of the fiber or nanotube, such as zeta potential or chemical reactivity.

The term “impregnated” is defined as the presence of other atoms or clusters inside of nanotubes. The phrase “filled carbon nanotube” is used interchangeably with “impregnated carbon nanotube.”

The term “doped” is defined as the insertion or existence of atoms, other than carbon, in the nanotube crystal lattice.

The term “charged” is defined as the presence of non-compensated electrical charge, in or on the surface of the carbon nanotubes or the additional fibers.

The term “irradiated” is defined as the bombardment of the nanotubes, the fibers, or both with beam of particles or rays such as x-rays with energy levels sufficient to cause inelastic interaction which makes change to the crystal lattice of the nanotube, fibers or both.

A “continuous method” refers to a method in which the deposition substrate continuously moves during the process until the fabrication of the nanostructured material is finished.

A “semi-continuous method” refers to a method in which the deposition substrate moves, in a stepwise fashion, during the fabrication process. Unlike the continuous process, the substrate can come to a stop during a semi-continuous method to allow a certain process to be performed, such as to allow multilayers to be deposited.

A “batch method” refers to a method in which the deposition substrate is stationary throughout the method.

The term “fluid” is intended to encompass liquids or gases.

The phrase “loaded carrier fluid,” refers to a carrier fluid that further comprises at least carbon nanotubes, and the optional components described herein, such as fibers or particles.

The term “contaminant(s)” means at least one unwanted or undesired element, molecule or organism in the fluid.

The term “removing” (or any version thereof) means destroying, modifying, or changing concentration of at least one contaminant using at least one of the following mechanisms: size exclusion, absorption, adsorption, chemical or biological interaction or reaction.

The phrases “chosen from” or “selected from” as used herein refers to selection of individual components or the combination of two (or more) components

B. Coated Fibers

The coated fibers described herein can be used to make filtration paper, which has been shown to be very effective in removing a variety of contaminants from fluid, without the previously described problems. For example, the nanostructured coating is more active than bulk material because of, inter alia, the smaller size of particles used and the higher chemical activity associated with the coated fibers. In addition, the nanoscale coating on the disclosed fibers not only results in a large surface area, but an excellent water permeability because it is applied to fibrous material. Also, as the resulting filtration paper can be manufactured using large scale wet or air laid techniques, it is very economical to produce.

It has been shown that by nano-structuring a filter media, the resulting filter has an increased material performance and decreased cost. In one embodiment, the support fiber may comprising a ceramic, polymer or metal fiber, which may or may not have at least one dimension on the nanoscale. Other ultra small diameter threads fibers or tubes, such as carbon nanotubes, may also be used.

The following disclosure more specifically describes a fiber comprising an active material that removes contaminants from fluid. The fibers disclosed herein, which in one embodiment do not comprise aluminum-oxygen compounds, serve as a support for an active material. It is to be appreciated that even though the fiber serves as a support structure, it will still remove, such as by size exclusion, contaminants from the fluid that passes through it.

The active material may comprise a non-fibrous, nanostructured, metal-oxygen compound that substantially coats the fiber. For example, metal-oxygen compound may comprise metal hydroxide Mₓ(OH)_{y}, oxyhydroxides MₓO_{y}(OH), oxide MₓO_{y}, oxy, hydroxy-, oxyhydroxy salts MₓO_{y}(OH)_{z}Aₙ or combinations of thereof in amorphous or/and crystalline form.

In the described metal-oxygen compound, M is at least one cation chosen from Magnesium, Aluminum, Calcium, Titanium, Manganese, Iron, Cobalt, Nickel, Copper, Zinc or combination of thereof.

A is an anion, which has at least one atom chosen from Hydrogen, Lithium, Beryllium, Boron, Carbon, Nitrogen, Oxygen, Fluorine, Neon, Sodium, Magnesium, Aluminum, Silicon, Phosphorus, Sulfur, Chlorine, Argon, Potassium, Calcium, Scandium, Titanium, Vanadium, Chromium, Manganese, Iron, Cobalt, Nickel, Copper, Zinc, Gallium, Germanium, Arsenic, Selenium, Bromine, Krypton, Rubidium, Strontium, Yttrium, Zirconium, Niobium, Molybdenum, Ruthenium, Rhodium, Palladium, Silver, Cadmium, Indium, Tin, Antimony, Tellurium, Iodine, Xenon, Cesium, Barium, Lanthanum, Cerium, Praseodymium, Neodymium, Promethium, Samarium, Europium, Gadolinium, Terbium, Dysprosium, Holmium, Erbium, Thulium, Ytterbium, Lutetium, Hafnium, Tantalum, Tungsten, Rhenium, Osmium, Indium, Platinum, Gold, Mercury, Thallium, Lead, Bismuth.

Nonlimiting example of anions are Hydride, Fluoride, Chloride, Bromide, Iodide, Oxide, Sulfide, Nitride, Sulfate, Thiosulfate, Sulfite, Perchlorate, Chlorate, Chlorite, Hypochlorite, Carbonate, Phosphate, Nitrate, Nitrite, Iodate, Bromate, Hypobromite, Borate, Silicate, organic anions, or combination of thereof.

The fiber may be chosen from natural and synthetic fibers, and may be made into a woven or non-woven material using an airlaid or wetlaid process described below. Such processes may be made either in a batch or continuous manner.

In one embodiment, the fibers have diameter from 1 nm to 10 mm, and are chosen from natural and synthetic fibers. Non-limiting examples of the synthetic fibers are those chosen from ceramic fibers, polymer fibers, and combinations thereof. For example, the ceramic fibers may comprise carbon fibers, glass fibers, asbestos fibers, quartz fibers, and combinations thereof.

Non-limiting examples of polymer fibers used in the present invention are those chosen from polyamides, including nylon, such as nylon-6 and nylon-6,6 and aramids; polyesters, including polyethylene terephthalate (PET).

Non-limiting examples of the natural fibers include those chosen from acrylic fibers, cellulose fibers, such as cotton, rayon, lignin and acetate, protein fibers, natural polymer fibers, or combination thereof.

Carbon fibers that may be used in the disclosed invention include graphite fibers, activated carbon fibers, carbon nanotubes and any combination thereof.

In one embodiment, the synthetic fibers are glass fibers that are comprised of micro fibers having an average BET diameter ranging from 50 nm to 20,000 nm.

Regardless of the type of fiber used for support, the nanostructured coating attached thereon is comprised of nano-particles or nano-layers ranging from 1 to 1,000 nm in at least one dimension. Non-limiting examples of the nanostructured coating comprise amorphous or crystalline structures.

In addition to being solid, it is also possible for the fiber used in the present disclosure to be hollow. When hollow, the previously described coating may be on the inside and/or outside of the fiber.

C. Method of Making Coated Fibers

The method of coated the previously described fibers may comprise depositing onto the fibers, from a liquid medium, a non-fibrous, nanostructured, metal-oxygen compound in an amount sufficient to remove at least one contaminant from fluid. The dispersion may be performed by stirring, ultrasonic treatment, high-shear mixing, colloidal milling, high-shear dispersion by applying high-pressure (including microfluidizing), or combination thereof.

In one embodiment, the metal compound comprises Fe, which forms a coating on the fiber having a density ranging from 0.06 to 600 mg/m² of fiber surface.

The liquid media, which may comprise aqueous and non-aqueous solutions, is used to initially dissolve at least one salt of a metal at an acidic pH. Once the metal salt is dissolved, the fibers, such as glass fibers, can be introduced into the solution. This may be performed while stirring, ultrasonication, high-shear mixing, colloidal milling, high-pressure dispersion, or combination thereof.

Next, a metal-oxygen compound is formed on the fibers by inducing hydrolysis of the metal cation from the dissolved metal compound. Non-limiting examples of how this hydrolysis is induced include introducing a base into the solution to alter the pH, heating or diluting the solution.

The induction of the hydrolysis of the metal cation is performed by increase of pH. This process is performed in a controlled manner, by itself or while increasing temperature. The induction of the hydrolysis typically is performed while agitating the solution and fibers. As used herein, “agitation” includes mixing, stirring, and the like.

The disclosed method may also be performed via a gas phase deposition technique. Such a process may comprise:
a) introducing fibers into a deposition chamber;
b) introducing a metal atom containing gaseous compound into a deposition chamber,
c) decomposing the gaseous compound under temperature and/or by introducing additional energy chosen from microwave, plasma, laser light, and combinations thereof,
d) forming a nanostructured coating of metal material on the fibers, and
e) reacting the metal material in a reactive gas stream to convert material to metal oxide or hydroxide, which may comprise oxidizing or reducing the metal material. The reactive gas may be comprised of oxygen, hydrogen, water vapor or any combination thereof.

The gas phase deposition technique described herein may be performed at pressures below atmospheric pressure (14.7 psi at sea level) to a range from 20 to 2,000 psi.

The foregoing method of making the nanostructure material described herein may be used in a continuous or batch manner. Non-limiting examples of these methods are provided below.

D. Filter Media, Method of Making and Method of Using

A method of making a filter media using a batch process according to the present disclosure may comprise dispersing at least one of the previously described fibers in liquid media to form a suspension, depositing the suspension on a substrate that is porous or permeable to the liquid media, wherein the deposition is driven by differential pressure filtration. In one embodiment, the present disclosure relates to a method of making a material for a filter media comprising coated fibers disclosed herein.

The substrate that may be used in the present disclosure can be comprised of fibrous or non-fibrous materials. Non-limiting examples of such fibrous and non-fibrous materials include metals, polymers, ceramic, natural fibers, and combinations thereof. In one embodiment, such materials are optionally heat and/or pressure treated prior to the depositing of the carbon nanotubes and/or coated fibers.

The method typically comprises suspending coated fibers, optionally with carbon nanotubes, in a carrier fluid to form a mixture, inducing the mixture to flow through a substrate that is permeable to the carrier fluid by differential pressure filtration, and depositing the glass fibers (and optional components such as carbon nanotubes), from the mixture onto the substrate.

The present disclosure also relates to a continuous or semi-continuous method for making the disclosed material comprising the coated fibers, such as a modified papermaking process. In this embodiment, the coated glass fibers are deposited from the mixture onto a moving substrate to form the disclosed material. This embodiment enables very large quantity of material to be formed, such as a material having at least one dimension greater than 1 meter, for example a length of hundreds or thousands of meters.

There is also disclosed a batch method for making a material comprising the coated fibers described herein. Unlike the continuous or semi-continuous method, the batch method comprises depositing the coated fibers from a mixture onto a stationary substrate that is permeable to the carrier fluid.

The method described herein may be used to make a wide variety of novel products, such as material for filtering fluids. This method may be used to directly deposit a seamless material onto a substrate that will become an integral part of the final product. In one embodiment, this method can be used to deposit the disclosed material onto a filter media, such as a porous carbon block.

Whether stationery or moving, the substrate may be chosen from fibrous materials, as well as woven, non-woven, and spunbond materials.

The substrate comprises a ridged, porous material, injection molded, carbon blocks, metals, sintered materials.

When a fibrous material is used, it may comprise a glass, carbon including all its allotropes, quartz, cellulose, polymers, metals, and combination thereof.

Further, through other testing of the inventive article other contaminants, such as those previously described (including metals, salts, organic and microbiological contaminants) can be removed from water and air.

Also disclosed is a filter media comprising the previously described fibers attached to a porous substrate, such as a carbon material, woven material, non-woven material, or combinations thereof. The porous substrate may be formed into any desired shape, depending on the end-use, such as a tubular, pleated, or flat shape.

In one embodiment, the porous substrate may be made of a material such as materials chosen from polyesters, polypropylene, aramids, polyphenylene sulfide (PPS), and acrylics and polyphenylene sulfide (PPS) fibers that exhibits exceptionally chemical resistance to most acids, alkalis, organic solvents, and oxidizers and elevated temperatures, and thus can be used where high temperatures, thermal stability, and/or chemical resistance is required.

The carbon material that may be used as a substrate in the present disclosure may comprise a tube or block of carbon, that is optionally hollow.

The woven materials that may be used herein are chosen from glass, or polymer fibers, non-limiting example of which are polyesters and PTFE. In addition, the non-woven materials are chosen from wood pulp, cotton, rayon, glass, cellulose fibers, organic fibers and films, that have been spunbonded, resin bonded, meltblown, wet laid or air laid, needle punched, into a non-woven substrate.

Also disclosed is a method of removing contaminants from fluid using the previously described coated fibers and filter media comprising the coated substrates. This method generally comprises passing fluid through a filter media comprising fibers having an active material attached thereon or therein, wherein the active material comprises a non-fibrous, nanostructured, metal-oxygen compound.

Non-limiting examples of the fluid that can be cleaned include:

(a) a liquid chosen from water, fuels, such as petroleum and its byproducts, biofuels, including any fuel made from a natural feedstock, such as corn (e.g., ethanol) or soy, biological fluids, foodstuffs, alcoholic beverages, and pharmaceuticals, or

(b) a gas chosen from air, industrial gases, and smoke from a vehicle, smoke stack, chimney, or cigarette, wherein the industrial gases comprise argon, nitrogen, helium, ammonia, and carbon dioxide.

Examples of the contaminants that can be removed include those chosen from particles, chemicals, and/or combination thereof. Non-limiting examples of such particles include microorganisms or their derivatives chosen from cysts, parasites, viruses, bacteria; pyrogens, prions, nucleic acids, proteins, endotoxins, enzymes, mycoplasma, yeast, fungus, and combinations thereof.

In addition, chemicals that can be removed from fluid are chosen from inorganic chemicals, organic chemicals, and combination thereof. As used herein, “chemicals” to be removed from the previously described fluids include dissolved gases.

Non-limiting examples of the inorganic chemicals comprise inorganic ions chosen from antimony, arsenic, beryllium, bromate, cadmium, chloramines, chlorine, chlorine dioxide, chlorite, chromium, copper, cyanide, fluoride, haloacetic acid, lead, mercury, nitrate, nitrite, phosphate, selenium, sulfur, thallium, trihalomethane, uranium, and derivatives thereof.

In one embodiment, the fluid to be cleaned with the disclosed filter media is a hydrocarbon-based petroleum, such as gasoline, and the contaminant to be removed is sulfur.

Non-limiting examples of the organic chemicals comprise organic compounds chosen from acrylamide, alachlor, atrazine, benzene, benzo(a)pyrene, carbofuran, carbon tetrachloride, chloradene, chlorobenzene, 2,4-Dichloro-phenoxyacetic acid, dalapon, 1,2-Dibromo-3-chloropropane, o-Dichlorobenzene, p-Dichlorobenzene, 1,2-Dichloroethane, 1,1-Dichloroethylene, 1,1-Dichloroethylene, trans-1,2-Dichloroethylene, Dichloromethane, 1,2-Dichloropropane, Di(2-ethylhexyl) adipate, Di(2-ethylhexyl) phthalate, Dinoseb, Dioxin, Diquat, Endothall, Endrin, Epichlorohydrin, Ethylbenzene, Ethylene dibromide, Glyphosate, Heptachlor, Heptachlor epoxide, Hexachlorobenzene, Hexachlorocyclopentadiene, Lindane, Methoxychlor, Oxamyl (Vydate), Polychlorinated biphenyls (PCBs), Pentachlorophenol, Perchlorate, Picloram, Simazine, Styrene, Tetrachloroethylene, Toluene, Toxaphene, Silvex, 1,2,4-Trichlorobenzene, 1,1,1-Trichloroethane, 1,1,2-Trichloroethane, Trichloroethylene, Vinyl chloride, Xylene, and derivatives thereof.

The invention will be further clarified by the following non-limiting examples, which are intended to be purely exemplary of the invention.

### EXAMPLE 1

### Oxyhydroxide Nano-Particles on Glass Fiber

The following exemplifies a coated glass fiber according to the present invention. In particular, the following process was used to produce a glass fiber having a nanostructured iron oxygen compound coated thereon.

Approximately 800±1 g of glass fiber material (about ¼ inch thick and of about the same size) was dispersed using a 3 blade propeller between 800 rpm and 1600 rpm in 156 liters of reversed osmosis (RO) water.

The glass fiber water dispersion was further dispersed with a SILVERSON™ High Shear In-Line Mixer Single Seal Model 200L. The operating frequency of the In-Line mixer was set to 75 Hz and a general purpose disintegrating head was used.

293±1 g of Ferric Nitrate Nonahydrate [Fe(NO₃)₃.9H₂O] was weighed out and dissolved in 1 liter±50 ml of water. This solution was stirred until completely dissolved. The Fe(NO₃)₃ solution was then added to the glass fiber water dispersion.

The mixture of Fe(NO₃)₃ solution and glass fibers was then mixed until the color equalized. During this process, the pH of the solution was 2.4. Stirring continued for at least 60 hours.

After stirring, 200±1 ml of sodium hydroxide, NaOH, 10 N solution was diluted to 4 L±20 ml in order to obtain 4 L of 0.50±0.05 N NaOH solution.

Using a Millipore Water Model 520 pump, 0.5±0.05 N NaOH solution was added at a rate of 2 ml/min. The titration continued until a pH=3.95±0.05, was achieved. Stirring continued for at least 2 days, at which time a pH value of 4.6±0.05 was achieved.

The foregoing process resulted in a glass fiber having Iron (III) Hydroxide coating thereon.

### EXAMPLE 2

### Oxyhydroxide Nano-Particles on Carbon Nanotubes

The following exemplifies coated carbon nanotubes made according to the present invention. In particular, the following process was used to produce carbon nanotubes having a nanostructured iron oxygen compound coated thereon.

Each of two 1.2 g samples of functionalized nanotubes were placed in 1 L beaker and sonicated in 700 ml of water for 30 minutes, using a Branson™ bath sonicator.

After sonicating, the two 1.2 g samples were used to prepare solutions, that were marked as Sample 1 and Sample 2.

In sample 1, 200 ml of 2.5 μL of Fe(NO₃)₃.9H₂O was added to the 1.2 g of nanotube under continuous stirring.

In sample 2, 200 ml of 12.5 g/L of Fe(NO₃)₃.9H₂O was added to the 1.2 g of nanotube, again under continuous stirring.

The initial pH values of samples 1 and 2 were measured and found to 2.97±0.02 and 2.36±0.02, respectively. The solutions were left under stirring for 24 hours in order to initiate Fe³⁺ hydrolysis.

After this slow rate hydrolysis the samples were titrated with a base (0.5 N solution of NaOH) at the titration rate 3 ml/min and constant stirring. The results are shown in Table 1.

TABLE 1

| | |
|---|---|
| Sample 1 | Sample 2 |
| 0.5 g Fe(NO₃)₃•9H₂O | 2.5 g Fe(NO₃)₃•9H₂O |

| Stir Time | Base amount | | Base amount | |
|---|---|---|---|---|
| (hours) | ml | pH | ml | pH |
| 0 | 0 | 2.97 | 0 | 2.36 |
| 24 | 0 | 2.66 | 0 | 2.45 |
| | 7 | 4.90 | 33.6 | 4.57 |
| 48 | — | 4.62 | — | 4.21 |
| 72 | | | — | 4.21 |
| | | | +0.2 | 4.62 |

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A fiber coated with an active material that assists in removing contaminants from fluid, wherein said active material comprises a nanostructured metal-containing compound on said fiber.

2. The fiber of claim 1, wherein said metal containing compound comprise metal-oxygen compounds chosen from metal hydroxide Mₓ(OH)_{y}, oxyhydroxides MₓO_{y}(OH)_{z}, oxide MₓO_{y}, oxy-, hydroxy-, oxyhydroxy salts MₓO_{y}(OH)_{z}Aₙ.

3. The fiber of claim 2, wherein M is at least one cation chosen from Magnesium, Aluminum, Calcium, Titanium, Manganese, Iron, Cobalt, Nickel, Copper, Zinc or combination of thereof.

4. The fiber of claim 2, wherein A comprises an anion having at least one atom chosen from Hydrogen, Lithium, Beryllium, Boron, Carbon, Nitrogen, Oxygen, Fluorine, Neon, Sodium, Magnesium, Aluminum, Silicon, Phosphorus, Sulfur, Chlorine, Argon, Potassium, Calcium, Scandium, Titanium, Vanadium, Chromium, Manganese, Iron, Cobalt, Nickel, Copper, Zinc, Gallium, Germanium, Arsenic, Selenium, Bromine, Krypton, Rubidium, Strontium, Yttrium, Zirconium, Niobium, Molybdenum, Ruthenium, Rhodium, Palladium, Silver, Cadmium, Indium, Tin, Antimony, Tellurium, Iodine, Xenon, Cesium, Barium, Lanthanum, Cerium, Praseodymium, Neodymium, Promethium, Samarium, Europium, Gadolinium, Terbium, Dysprosium, Holmium, Erbium, Thulium, Ytterbium, Lutetium, Hafnium, Tantalum, Tungsten, Rhenium, Osmium, Indium, Platinum, Gold, Mercury, Thallium, Lead, Bismuth, and combinations thereof.

5. The fiber of claim 1, wherein said fibers are chosen from natural and synthetic fibers.

6. The fiber of claim 5, wherein said synthetic fibers are chosen from ceramic fibers, polymer fibers, and combinations thereof.

7. The fiber of claim 6, wherein said polymer fibers comprise polyamides, aramids, polyphenylene sulfide (PPS) fibers, and polyesters.

8. The fiber of claim 6, wherein said ceramic fibers comprise carbon, glass, quartz, asbestos, and combinations thereof.

9. The fiber of claim 6, wherein said natural fibers are chosen from cellulose, protein, natural polymer, or combination thereof.

10. The fiber of claim 8, wherein said carbon fibers are comprised of graphite, activated carbon, carbon nanotubes, diamond and any combination thereof.

11. The fiber of claim 8, wherein said glass fibers are comprised of micro fibers having an average diameter ranging from 10 nm to 20 mm.

12. The fiber of claim 1, wherein said nanostructured coating is comprised of nano-particles or nano-layers ranging from 1 to 1,000 nm in at least one dimension.

13. The fiber of claim 1, wherein said fiber comprises a hollow tube.

14. The fiber of claim 13, wherein said coating is located on the inside or outside of the hollow tube.

15. The fiber of claim 1, wherein when said metal comprises Fe, the coating on said fiber comprises Fe having a surface density ranging from 0.06 μg/m² to 600 mg/m².

16. A method of coating fibers with a nanostructured material, said method comprising:
depositing onto said fibers, from a liquid and/or gas phase, a nanostructured, metal-containing compound in an amount sufficient to decrease the concentration of at least one contaminant in a fluid.

17. The method of claim 16, wherein said fiber does not comprise aluminum-oxygen compounds.

18. The method of claim 16, wherein liquid media comprises aqueous solutions and non-aqueous solutions.

19. The method of claim 16, wherein said depositing comprises:
a) dissolving at least one compound of a metal at an acidic pH in an aqueous solution;
b) introducing fibers into said aqueous solution to form a mixture; and
c) inducing hydrolysis of a metal cation to form a metal-oxygen compound.

20. The method of claim 19, wherein said inducing hydrolysis in (c) is performed by increasing pH in a controlled process and/or increasing temperature while agitating said mixture.

21. The method of claim 20, wherein said depositing is performed at a pressure from 20 to 2,000 psi.

22. The method of claim 20, wherein said depositing occurs from the gas phase and comprises:
a) introducing fibers into a deposition chamber;
b) introducing a metal containing gaseous compound into a deposition chamber,
c) decomposing said gaseous compound under temperature and/or by introducing additional energy chosen from microwave, plasma, laser light, and combinations thereof,
d) forming a nanostructured coating of metal material on said fibers, and
e) reacting said metal material in a reactive gas stream to convert material to metal oxide.

23. The method of claim 16, which is performed below atmospheric pressure.

24. The method of claim 22, wherein said reacting in (e) comprises oxidizing or reducing said metal material.

25. The method of claim 22, wherein said reactive gas is comprised of oxygen, hydrogen, water vapor or any combination thereof.

26. The method of claim 16, wherein said metal containing compounds comprise metal-oxygen compounds chosen from metal hydroxide Mₓ(OH)_{y}, oxyhydroxides MₓO_{y}(OH)_{z}, oxide MₓO_{y}, oxy-, hydroxy-, oxyhydroxy salts MₓO_{y}(OH)_{z}Aₙ.

27. The method of claim 26, wherein M is at least one cation chosen from Magnesium, Aluminum, Calcium, Titanium, Manganese, Iron, Cobalt, Nickel, Copper, Zinc, or combinations of thereof.

28. The method of claim 26, wherein A comprises an anion having at least one atom chosen from Hydrogen, Lithium, Beryllium, Boron, Carbon, Nitrogen, Oxygen, Fluorine, Neon, Sodium, Magnesium, Aluminum, Silicon, Phosphorus, Sulfur, Chlorine, Argon, Potassium, Calcium, Scandium, Titanium, Vanadium, Chromium, Manganese, Iron, Cobalt, Nickel, Copper, Zinc, Gallium, Germanium, Arsenic, Selenium, Bromine, Krypton, Rubidium, Strontium, Yttrium, Zirconium, Niobium, Molybdenum, Ruthenium, Rhodium, Palladium, Silver, Cadmium, Indium, Tin, Antimony, Tellurium, Iodine, Xenon, Cesium, Barium, Lanthanum, Cerium, Praseodymium, Neodymium, Promethium, Samarium, Europium, Gadolinium, Terbium, Dysprosium, Holmium, Erbium, Thulium, Ytterbium, Lutetium, Hafnium, Tantalum, Tungsten, Rhenium, Osmium, Indium, Platinum, Gold, Mercury, Thallium, Lead, Bismuth, and combinations thereof.

29. The method of claim 16, wherein said fiber comprises a hollow tube, and the coating is located on the inside, outside or both, of the hollow tube.

30. The method of claim 27, wherein when said metal comprises Fe, the coating on said fiber comprises Fe in a density ranging from 0.06 to 600 mg/m² of fiber surface.

31. A method for producing a filter media, said method comprising:
forming a liquid suspension of fibers coated with an active material comprising a nanostructured, metal-containing compound, and
depositing said suspension on porous substrate, wherein said depositing is driven by differential pressure.

32. The method from claim 31, where said deposition is performed on a stationery substrate.

33. The method from claim 31, where said deposition is performed on a moving substrate.

34. The method from claim 31, wherein the porous substrate is chosen from fibrous materials fabricated into a woven, non-woven, or spunbond material.

35. The method of claim 34, wherein said porous substrate comprises ceramic, cellulose, polymers, metals, and combination thereof.

36. The method of claim 31, wherein said metal-containing compounds comprise metal-oxygen compounds chosen from metal hydroxide Mₓ(OH)_{y}, oxyhydroxides MₓO_{y}(OH)₂, oxide MₓO_{y}, oxy-, hydroxy-, oxyhydroxy salts MₓO_{y}(OH)_{z}Aₙ.

37. The method of claim 36, wherein M is at least one cation chosen from Magnesium, Aluminum, Calcium, Titanium, Manganese, Iron, Cobalt, Nickel, Copper, Zinc or combination of thereof.

38. The method of claim 36, wherein A comprises an anion having at least one atom chosen from Hydrogen, Lithium, Beryllium, Boron, Carbon, Nitrogen, Oxygen, Fluorine, Neon, Sodium, Magnesium, Aluminum, Silicon, Phosphorus, Sulfur, Chlorine, Argon, Potassium, Calcium, Scandium, Titanium, Vanadium, Chromium, Manganese, Iron, Cobalt, Nickel, Copper, Zinc, Gallium, Germanium, Arsenic, Selenium, Bromine, Krypton, Rubidium, Strontium, Yttrium, Zirconium, Niobium, Molybdenum, Ruthenium, Rhodium, Palladium, Silver, Cadmium, Indium, Tin, Antimony, Tellurium, Iodine, Xenon, Cesium, Barium, Lanthanum, Cerium, Praseodymium, Neodymium, Promethium, Samarium, Europium, Gadolinium, Terbium, Dysprosium, Holmium, Erbium, Thulium, Ytterbium, Lutetium, Hafnium, Tantalum, Tungsten, Rhenium, Osmium, Indium, Platinum, Gold, Mercury, Thallium, Lead, Bismuth, and combinations thereof.

39. The method of claim 31, wherein said fiber comprises a hollow tube, and the coating is located on the inside, outside or both, of the hollow tube.

40. The method of claim 37, wherein when said metal comprises Fe, the coating on said fiber comprises Fe in a density ranging from 0.06 to 600 mg/m² of fiber surface.

41. A method of removing contaminants from fluid, said method comprising passing said fluid through a filter media comprising fibers coated with an active material, wherein said active material comprises a nanostructured, metal-containing compound.

42. The method of claim 41, wherein the fluid comprises:
(a) a liquid chosen from water, petroleum and its byproducts, biological fluids, foodstuffs, alcoholic beverages, and pharmaceuticals, or
(b) a gas chosen from air, industrial gases, and smoke from a vehicle, smoke stack, chimney, or cigarette, wherein said industrial gases comprise argon, nitrogen, helium, ammonia, and carbon dioxide.

43. The method of claim 41, where said contaminants are chosen from particles, chemicals, and/or combination thereof.

44. The method of claim 43, wherein said particles are microorganisms or their derivatives chosen from cysts, parasites, viruses, bacteria, pyrogens, prions, nucleic acids, proteins, endotoxins, enzymes, mycoplasma, yeast, fungus, and combinations thereof.

45. The method of claim 43, wherein said chemicals are chosen from inorganic chemicals, organic chemicals, and combination thereof.

46. The method of claim 45, wherein said inorganic chemicals comprise inorganic ions chosen from antimony, arsenic, beryllium, bromate, cadmium, chloramines, chlorine, chlorine dioxide, chlorite, chromium, copper, cyanide, fluoride, haloacetic acid, lead, mercury, nitrate, nitrite, phosphate, selenium, thallium, trihalomethane, uranium, and derivatives thereof.

47. The method of claim 45, wherein said organic chemicals comprise organic compounds chosen from acrylamide, alachlor, atrazine, benzene, benzo(a)pyrene, carbofuran, carbon tetrachloride, chloradene, chlorobenzene, 2,4-Dichloro-phenoxyacetic acid, dalapon, 1,2-Dibromo-3-chloropropane, o-Dichlorobenzene, p-Dichlorobenzene, 1,2-Dichloroethane, 1,1-Dichloroethylene, 1,1-Dichloroethylene, trans-1,2-Dichloroethylene, Dichloromethane, 1,2-Dichloropropane, Di(2-ethylhexyl) adipate, Di(2-ethylhexyl) phthalate, Dioxin, Diquat, Endothall, Endrin, Epichlorohydrin, Ethylbenzene, Ethylene dibromide, Glyphosate, Heptachlor, Heptachlor epoxide, Hexachlorobenzene, Hexachlorocyclopentadiene, Lindane, Methoxychlor, Oxamyl (Vydate), Polychlorinated biphenyls (PCBs), Pentachlorophenol, Perchlorate, Picloram, Simazine, Styrene, Tetrachloroethylene, Toluene, Toxaphene, Silvex, 1,2,4-Trichlorobenzene, 1,1,1-Trichloroethane, 1,1,2-Trichloroethane, Trichloroethylene, Vinyl chloride, Xylene, and derivatives thereof.

48. The method of claim 41, wherein said fibrous material comprises a ceramic, cellulose, polymers, metals, and combination thereof.

49. The method of claim 41, wherein said fiber does not comprise aluminum-oxygen compounds.

50. The method of claim 41, wherein said metal-containing compounds comprise metal-oxygen compounds chosen from metal hydroxide Mₓ(OH)_{y}, oxyhydroxides MₓO_{y}(OH)_{z}, oxide MₓO_{y}, oxy-, hydroxy-, oxyhydroxy salts MₓO_{y}(OH)_{z}Aₙ.

51. The method of claim 50, wherein M is at least one cation chosen from Magnesium, Aluminum, Calcium, Titanium, Manganese, Iron, Cobalt, Nickel, Copper, Zinc or combination of thereof.

52. The method of claim 50, wherein A comprises an anion having at least one atom chosen from Hydrogen, Lithium, Beryllium, Boron, Carbon, Nitrogen, Oxygen, Fluorine, Neon, Sodium, Magnesium, Aluminum, Silicon, Phosphorus, Sulfur, Chlorine, Argon, Potassium, Calcium, Scandium, Titanium, Vanadium, Chromium, Manganese, Iron, Cobalt, Nickel, Copper, Zinc, Gallium, Germanium, Arsenic, Selenium, Bromine, Krypton, Rubidium, Strontium, Yttrium, Zirconium, Niobium, Molybdenum, Ruthenium, Rhodium, Palladium, Silver, Cadmium, Indium, Tin, Antimony, Tellurium, Iodine, Xenon, Cesium, Barium, Lanthanum, Cerium, Praseodymium, Neodymium, Promethium, Samarium, Europium, Gadolinium, Terbium, Dysprosium, Holmium, Erbium, Thulium, Ytterbium, Lutetium, Hafnium, Tantalum, Tungsten, Rhenium, Osmium, Indium, Platinum, Gold, Mercury, Thallium, Lead, Bismuth, and combinations thereof.

53. The method of claim 41, wherein said fiber comprises a hollow tube, and the coating is located on the inside, outside or both, of the hollow tube.

54. The method of claim 41, wherein when said metal comprises Fe, the coating on said fiber comprises Fe in a density ranging from 0.06 to 600 mg/m² of fiber surface.

55. A filter media comprising:
a porous substrate; and
coated fibers located on said porous substrate, wherein the coating on said fibers comprises a nanostructured, metal-containing compound.

56. The filter media of claim 55, wherein said porous substrate comprises ceramic material including carbon material, woven material, non-woven material, or combinations thereof.

57. The filter media of claim 55, wherein said porous substrate has a tubular, pleated, or flat shape.

58. The filter media of claim 55, wherein said porous substrate exhibits anti-static properties and comprises materials chosen from polyesters, polypropylene, aramids, polyphenylene sulfide (PPS), and acrylics.

59. The filter media of claim 55, wherein said carbon material comprises a tube or block of carbon, that is optionally hollow.

60. The filter media of claim 56, wherein said woven materials are chosen from glass, polyesters, nylon, and PTFE.

61. The filter media of claim 56, wherein said non-woven materials are chosen from wood pulp, cotton, rayon, glass fibers, organic fibers and films, and cellulose materials that have been spunbonded, resin bonded, meltblown, wet laid or air laid, needle punched, into a non-woven substrate.

62. The filter media of claim 55, wherein said metal containing compounds comprise metal-oxygen compounds chosen from metal hydroxide Mₓ(OH)_{y}, oxyhydroxides MₓO_{y}(OH)_{z}, oxide MₓO_{y}, oxy-, hydroxy-, oxyhydroxy salts MₓO_{y}(OH)_{z}Aₙ.

63. The filter media of claim 62, wherein M is at least one cation chosen from Magnesium, Aluminum, Calcium, Titanium, Manganese, Iron, Cobalt, Nickel, Copper, Zinc or combination of thereof.

64. The filter media of claim 62, wherein A comprises an anion having at least one atom chosen from Hydrogen, Lithium, Beryllium, Boron, Carbon, Nitrogen, Oxygen, Fluorine, Neon, Sodium, Magnesium, Aluminum, Silicon, Phosphorus, Sulfur, Chlorine, Argon, Potassium, Calcium, Scandium, Titanium, Vanadium, Chromium, Manganese, Iron, Cobalt, Nickel, Copper, Zinc, Gallium, Germanium, Arsenic, Selenium, Bromine, Krypton, Rubidium, Strontium, Yttrium, Zirconium, Niobium, Molybdenum, Ruthenium, Rhodium, Palladium, Silver, Cadmium, Indium, Tin, Antimony, Tellurium, Iodine, Xenon, Cesium, Barium, Lanthanum, Cerium, Praseodymium, Neodymium, Promethium, Samarium, Europium, Gadolinium, Terbium, Dysprosium, Holmium, Erbium, Thulium, Ytterbium, Lutetium, Hafnium, Tantalum, Tungsten, Rhenium, Osmium, Indium, Platinum, Gold, Mercury, Thallium, Lead, Bismuth, and combinations thereof.

65. The filter media of claim 55, wherein said fibers are chosen from natural and synthetic fibers.

66. The filter media of claim 65, wherein said synthetic fibers are chosen from ceramic fibers, polymer fibers, and combinations thereof.

67. The filter media of claim 66, wherein said polymer fibers comprise polyamides, aramids, polyphenylene sulfide (PPS) fibers, and polyesters.

68. The filter media of claim 66, wherein said ceramic fibers comprise carbon, glass, quartz, asbestos, and combinations thereof.

69. The filter media of claim 75, wherein said natural fibers are chosen from cellulose fibers, protein fibers, natural polymer fibers, or combination thereof.

70. The filter media of claim 68, wherein said carbon fibers are comprised of graphite fibers, activated carbon fibers, carbon nanotubes and any combination thereof.

71. The filter media of claim 68, wherein said glass fibers are comprised of micro fibers having an average diameter ranging from 10 nm to 5 mm.

72. The filter media of claim 55, wherein when said metal comprises Fe, the coating on said fiber comprises Fe having a density ranging from 0.06 μg/m² to 600 mg/m².
